(19) United States
(12) Patent Application Publication
(10) Pub. No.: US 2004/0090573 A1
(43) Pub. Date: May 13, 2004

(54) Screen with asymmetric light diffusing characteristic

(76) Inventors: Alison Mary Fairhurst, Oxfordshire (GB); Keren Hamilton, Swindon (GB); James Finlayson, Merseyside (GB)

Correspondence Address: Kent E Baldauf Sr, 700 Koppers Building, 436 Seventh Avenue, Pittsburgh, PA, 15219-1818, US

(21) Appl. No.: 10/297,824

(22) PCT Filed: Jun. 12, 2001
(86) PCT No.: PCT/GB01/02560

(30) Foreign Application Priority Data
Jun. 12, 2000 (GB) 00142976
Aug. 14, 2000 (GB) 00199760

(51) Int. Cl. G02F 1/1335

(52) U.S. Cl. 349/113

(57) ABSTRACT

A generally planar light-diffusing sheet or screen has, in one embodiment of the invention, off-axis characteristics such that the maximum aligned gain, is at significant angle with respect to the normal to the plane of the sheet or screen. In another embodiment, the maximum gain is at an angle of 0° to 20° to the normal to the plane of the sheet or screen. The screen may be a photopolymer diffuser in which the light diffusive characteristics are due at least partly to refractive index variations within the material of the diffuser, and wherein said refractive index variations define graded refractive index lenses or analogous optical features having optical axes which are inclined with respect to the normal to the plane of such sheet or screen.

THIS INVENTION relates to video displays and is of particular utility in relation to LCD displays, but is also applicable, inter alia, to image projection systems.

In liquid crystal displays, the image seen by the viewer is generated through the liquid crystal cell either by light generated within the assembly by a back light or by the use of ambient light which is first transmitted through the cell and reflected at the rear of the cell re-emerging through the cell to create an image. In the latter arrangement, due to the position of the head of the viewer, the majority of the ambient light to the display must be accepted off-axis. The applicants have concluded that ambient light reaching the display should ideally not be further diffused on entering the display, but that a measure of diffusion of the light leaving the display is desirable in order to provide acceptable viewing characteristics.

It is an object of the present invention, in one aspect, to provide, in an LCD display, a light-diffusing screen having characteristics such as to provide improved viewing in ambient light viewing conditions in the normal conditions applying in practice.

In accordance with this aspect of the invention there is provided an LCD or the like display incorporating a light transmissive diffuser in front of the liquid crystal so as to be interposed between the liquid crystal and the viewer, and wherein said light diffuser is an off-axis diffuser, as herein defined, disposed so that the maximum aligned gain, as herein defined, is at an angle above the normal to the plane of the LCD display, in the normal viewing orientation of the display.

In certain applications, it is preferable for the plane of the display to be normal to the viewer's line of sight, so that a measure of diffusion of ambient light reaching the display from angles other than the normal is necessary (since the viewer's head obstructs light directed towards the display along the normal) for reflected light to reach the viewer's eye along the normal.

It is an object of the invention, in another of its aspects, to provide, in an LCD display, a light-diffusing screen having characteristics such as to provide improved viewing in ambient light viewing conditions in which the display is viewed substantially along the normal to the display.

In accordance with this aspect of the invention there is provided an LCD or the like display incorporating a light transmissive diffuser in front of the liquid crystal so as to be interposed between the liquid crystal and the viewer, and wherein said light diffuser is such that the maximum gain, as herein defined, is substantially normal to the plane of the LCD display.

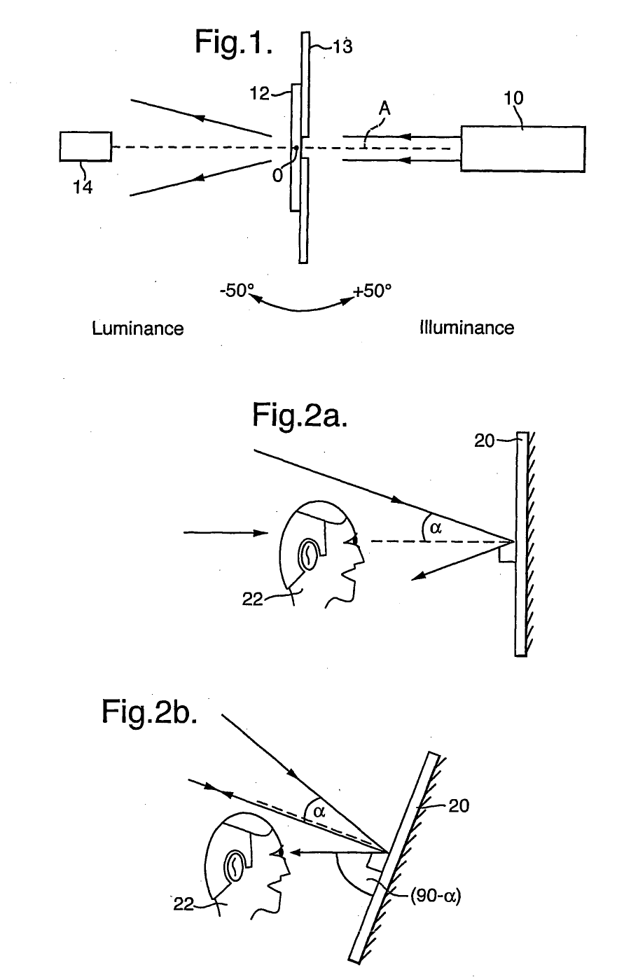

The terms “gain” and “aligned gain” as used herein are best explained by reference to FIG. 1 herein, wherein reference 10 indicates a source of collimated (parallel) light; reference 14 indicates a photometer and reference 12 indicates a planar light diffusing screen interposed between the light source and the photometer and supported by a support 13 rotatable about an axis O with the screen 12. The gain, as used herein, of the screen 12 is defined as

$$Gain = \frac{Luminance ( fL )}{Illuminance ( fC )}$$

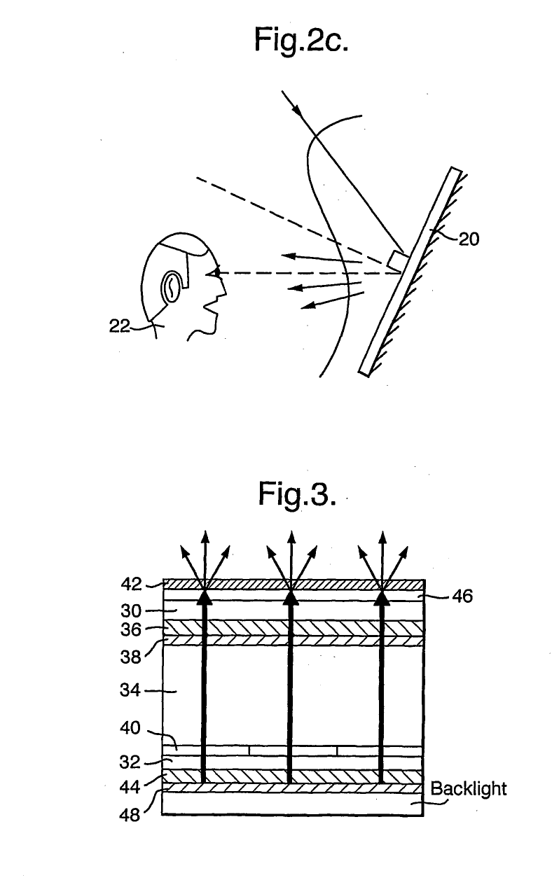

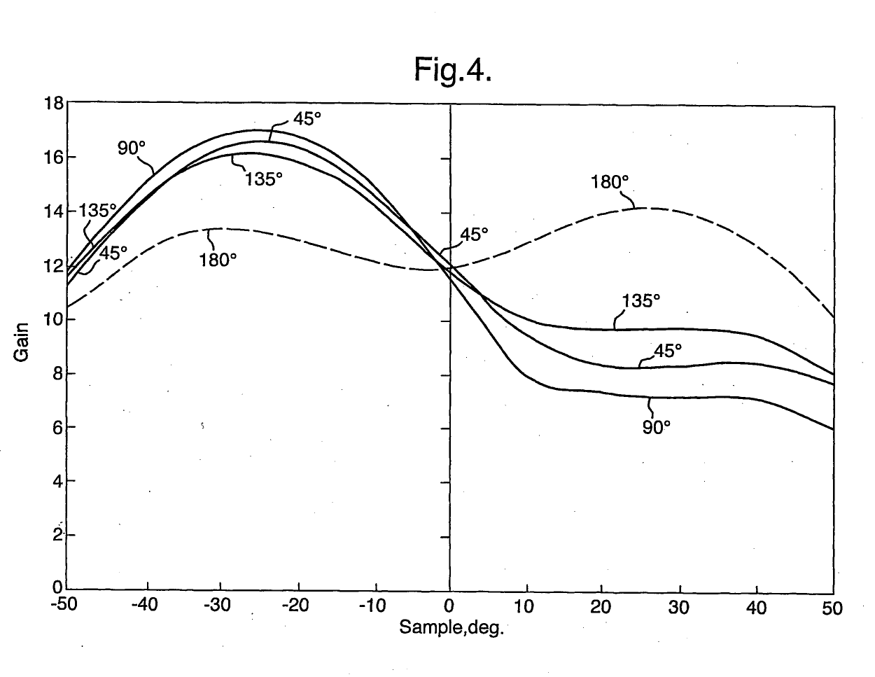

Considered in another way, the gain, in the scenario illustrated in FIG. 1, is a measure of the brightness of the illuminated part of the screen 12, as measured by the photometer 14 as compared with the corresponding brightness if the screen 12 were replaced by an ideal Lambertian diffuser, (i.e. a diffuser emitting light equally in all directions). (The term “ideal” in this context is not, of course, intended to mean that such a diffuser would best meet the requirements for a diffusive screen for an LCD display). The term “aligned” gain, as used herein in relation to screen 12 means the gain of the screen measured with the photometer 14 aligned with the light source 10, i.e. with the light source 10 being arranged to direct its light along an axis A passing through the photometer 14 and the photometer 14 being disposed to most efficiently receive light incident thereon along said axis A. If the photometer 14 is mounted so that it can be swung about an axis O perpendicular to the plane of FIG. 1 and passing through the screen 12, then, in general, for a constant light flux from the light source 10, the light flux reaching the photometer 14 will vary with the angle of the photometer axis about the axis O, relative to the axis of the beam from the light source 10 and it will be possible, inter alia, to construct a graph of the variation in gain with said angle of the photometer axis about the axis O. Such graphs are shown in FIG. 2 and FIG. 3 herein, described in detail later. If the screen 12 is mounted so that it can be pivoted about an axis O perpendicular to the plane of FIG. 1 and passing through the axis A, then, in general, for a constant light flux from the light source 10, the light flux reaching the photometer 14 will vary with the angle of the screen 12 about the axis O and it will be possible, inter alia, to construct a graph of the variation in “aligned gain” with angle of screen 12 about the axis O. Such a graph is shown in FIG. 4.

It will be understood that, on the basis that there is no significant absorption of light by the diffuser, if the diffuser has a high aligned gain in a particular direction, light passing in that direction will be only slightly diffused and conversely if the diffuser has a low aligned gain in a particular direction, light passing in that direction will be greatly diffused.

Relevant features of preferred embodiments of the invention will appear from the following description with reference to the accompanying drawings in which:—

FIG. 1 is a schematic plan view of a test apparatus and sample and illustrates, as noted above, the measurement of “aligned gain” as that term is used herein;

FIGS. 2a to 2c are diagrams illustrating an application of the invention,

FIG. 3 is a schematic sectional view of part of an LCD display, in section, to a much enlarged scale, and

FIG. 4 is a graph illustrating variation of aligned gain with angular orientation of the screen 12 about axis O in the measurement scenario of FIG. 1,

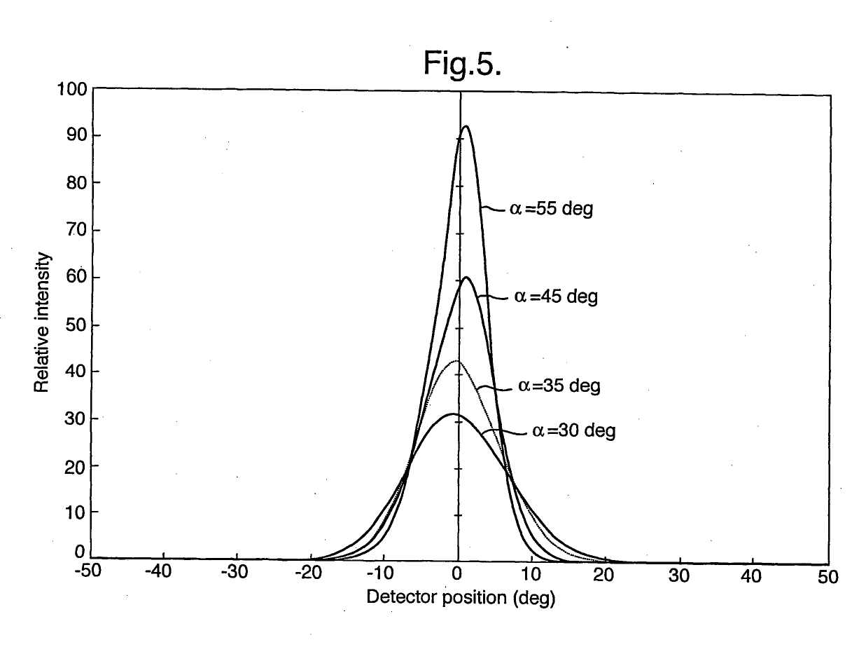

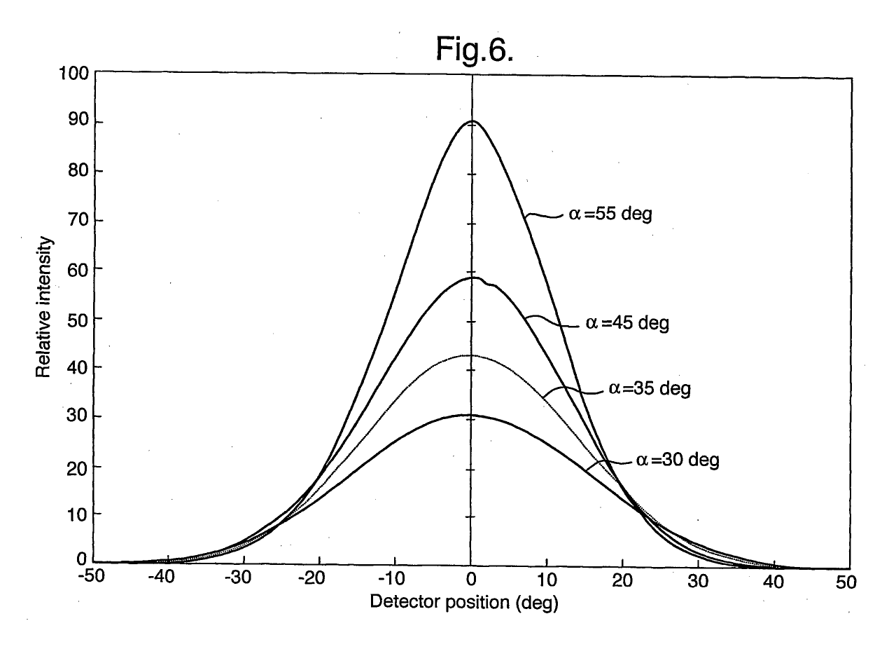

FIGS. 5 and 6 are graphs showing variations in relative intensity with viewing angle for various light diffusing screens.

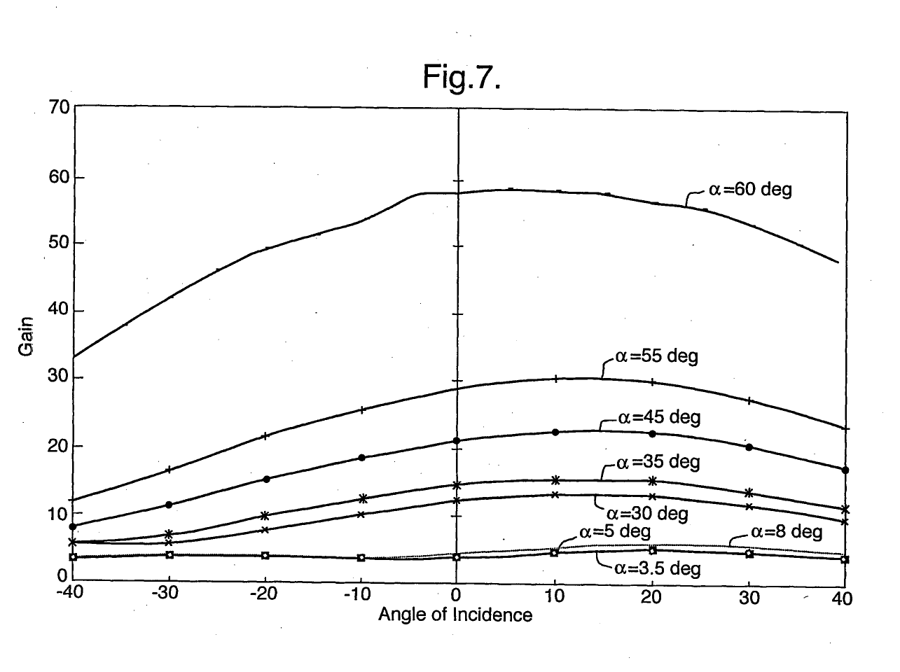

FIG. 7 is a graph illustrating variation of aligned gain with angular orientation of the screen 12 about axis O in the measurement scenario of FIG. 1, for various diffusion screens.

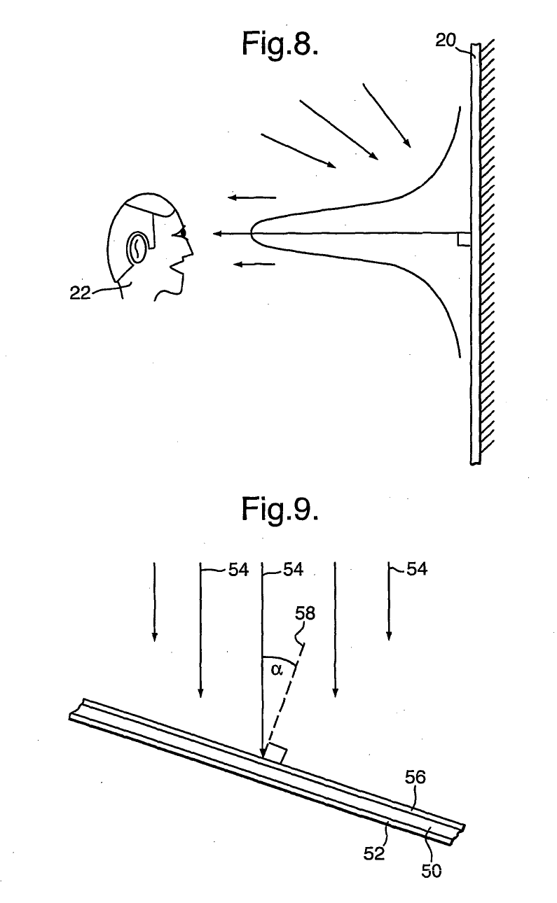

FIG. 8 is a diagram illustrating another application of the invention, and

FIG. 9 is a schematic sectional view illustrating manufacture of a diffuser in accordance with this other application of the invention.

Referring to the accompanying drawings, and particularly to FIGS. 2a to 2c, FIG. 2a illustrates schematically the use of an LCD display 20, (for example a pixelated LCD display forming the screen of a hand-held device such as a mobile telephone, a PDA, an electronic game device, which principally depends upon ambient light for viewing the display, or possibly the screen of a portable “lap top” computer operated in a mode relying upon ambient illumination). Such LCD displays typically incorporate a liquid crystal cell and a reflector behind the liquid crystal cell, as discussed above and below, arranged to reflect, to the viewer, back through the cell, ambient light which has already passed through the cell. FIGS. 2a to 2c illustrate that, in normal viewing conditions, the person viewing the screen has his or her back to the light. FIG. 2a illustrates that if the LCD display is disposed so as to be exactly perpendicular to the viewer's line of sight, the viewer's head 22 blocks the light which would otherwise reach the screen along the normal to the screen, indicated by the broken line. Accordingly, in normal use of such an LCD display, the viewer typically must rely upon light emanating from areas behind the viewer and above his or her head so that, as illustrated, the light illuminating the display 20 is incident on the screen 20 at an angle α with respect to the normal. This means that if the display were to be viewed exactly along the normal to the plane of the display as illustrated in FIG. 2a, a major part of the light reflected from the display would be directed downwardly below the viewer's line of sight. For this reason, a typical viewer will tilt the screen 20 relative to his or her line of sight as illustrated in FIG. 2b in order to view a brighter image.

The representation in FIGS. 2a and 2b of the light passing to and reflected from the LCD is consistent with the reflector behind the LCD cell being a specular plane mirror. As noted above, in order to provide an acceptable viewing cone, i.e. in order that acceptable viewing of the screen may be had from a range of different angular positions relative to the normal to the screen, it is normal to arrange for some diffusion of the light reflected from the display, either by arranging for the reflector in the display itself to be partially light diffusing in character and/or by arranging a light diffusing sheet at a position in front of the liquid crystal cell. Nevertheless the light emerging from the display is significantly directional. The invention is applicable, inter alia, to a light diffusing sheet disposed in front of such a liquid crystal cell, and also, or alternatively, to a diffusive reflector disposed behind the liquid crystal cell in this context.

Referring to FIG. 3, a typical LCD display (colour display in the case illustrated) comprises front and rear parallel glass plates 30 and 32 respectively spaced apart and accommodating a twisted nematic liquid crystal layer 34 therebetween, the front glass 30 typically having, on its face nearest the liquid crystal layer 34, a colour filter 36 and, directly adjoining the liquid crystal layer, a common electrode 38. The rear glass plate 32 typically has, on its surface immediately adjoining the liquid crystal layer 34, individual electrodes 40, which, in a case where the display is a pixelated display, will be individual pixel electrodes. A polarising layer 42 surmounts the upper glass 30 and a polarising layer 44 is provided on the underside of the glass 32, all in manner known per se. Likewise, beneath the polariser 44 is provided a light reflector 48 (or “transflector” i.e. a partially light reflecting/partially light transmitting layer—typically employed where a back light is provided for illuminating the display in low ambient light conditions). In the arrangement shown in FIG. 3, a light diffusing film 46 is interposed between the polariser 42 and the glass 30. (A so-called retardation film is commonly provided in association with the upper polariser in LCD displays and such a retardation film may be provided directly below the upper polariser 42, above the light diffusing film 46). Instead of (or in addition to) providing light diffusing film 46 in front of (above in FIG. 3) the liquid crystal, the reflector or transflector 48 may have light diffusing properties in accordance with the invention.

Referring again to FIGS. 2a to 2c, and assuming the display 20 to incorporate a light diffusing film 46 as discussed in relation to FIG. 3, for the purposes of the discussion which follows, light incident on the diffusing screen in a direction which is inclined downwardly with respect to the normal to the plane of the display is considered, arbitrarily, to be incident at a negative angle with respect to that normal, whilst light exiting through the diffusing screen, after reflection within the display 20, in a direction downwardly and away from the normal, (back towards the viewer in FIGS. 2a to 2c), is considered, arbitrarily, to have a positive angle of inclination with respect to the normal. That is to say, in the measuring scenario shown in FIG. 1, light from the light source 10 passing along axis A to the screen 12, is considered to enter the screen at a negative angle if the screen is inclined from bottom left to top right of the figure and to enter the screen 12 at a positive angle if the screen is inclined from bottom right to top left in FIG. 1.

The applicants have found that surprisingly good viewing properties, in the reflective mode illustrated in FIGS. 2a to 2c, are provided if the diffusion film 46 or the reflector or transflector 48 has the characteristics illustrated by the graph referenced 90 in FIG. 4. That is to say, if for light incident on the screen 20 downwardly, from above the viewer's head, such light is diffused to a relatively small degree in passing through the screen (high aligned gain), whilst, after reflection in the display, for example, by the reflector or transflector 48, such light, in passing back through the diffusing layer at a negative angle is significantly more diffused (with corresponding lower gain). For clarity, a graph corresponding to FIG. 4 has been superimposed on the display in FIG. 2c to illustrate more clearly the relationship between the viewing conditions and the variation of aligned gain with angle of incidence. Subjectively the result of using a light-diffusing film having the characteristics is that the display has, as compared with conventional displays, increased brightness as compared with conventional screens over a wide range of viewing positions and is less sensitive than conventional viewing screens to the angular position of overhead (or rearward and overhead) light sources providing illumination for the display.

It will be appreciated that a light diffusing material having the characteristics illustrated in FIG. 4 is asymmetric in the sense that the diffusion characteristics described are dependent upon the orientation of a preferred axis, lying in the plane of the diffusing sheet, with respect to the axis O (in the testing set up illustrated in FIG. 1), about which the angles represented in the graph of FIG. 4 are measured. Suppose that such preferred axis is defined as an axis such that, when it is perpendicular to the axis O in FIG. 1, the maximum gain on the negative angular quadrant in the graph of FIG. 4 is greatest. (This is, of course, the orientation utilised in the arrangement of FIG. 2c in accordance with the invention). When that preferred axis is parallel with the axis O in FIG. 1, the curve of gain versus angle is typically as indicated at 180 in FIG. 4 which is, it will be noted, substantially symmetrical about the vertical “gain” axis of the graph, and is, additionally, for the material concerned, approximately flat over a wide range of angles about the “normal” (0°) position. Thus, as implicit in FIG. 4, the display can be viewed comfortably from a relatively wide range of horizontal positions. (FIG. 4 shows, for the measuring set-up shown in FIG. 1, at 45 and 135 the results obtained when the preferred axis is inclined, respectively, at 45° and 135° relative to the “angle of adjustment” axis O.

The applicants' currently preferred method of producing an off-axis diffusion screen material with the characteristics noted is by exposure of a photopolymer material to polymerising radiation through an optical mask, preferably a speckle mask, as described, for example, in WO94/29768 or EP-A-0768565, but with the layer of photopolymer, (or rather the layer of monomer which forms a precursor of the photopolymer layer), in the exposure step, being exposed, through the speckle mask, to collimated (parallel) polymerising radiation which is projected in a direction which is inclined with respect to the normal to the planes of the monomer layer and the superimposed mask, whereby, throughout the exposed monomer/polymer, the radiation passes everywhere at the same exposure angle, through the mask, with respect to the plane of the layer of monomer/polymer. The degree of asymmetry, or, the extent to which the resultant material is “off-axis” depends upon the exposure angle selected, and thus the desired characteristics of the light diffusing film in the present invention, can be selected by appropriate selection of the exposure angle.

As noted above, it is possible to produce results similar to those described either using a transmissive light-diffusing film (46), having the properties described, in front of the LCD cell, or using a light-diffusing reflector or transflector, having corresponding off-axis properties, behind the liquid crystal cell, (or indeed by having such a reflector or transflector behind the liquid crystal cell in addition to such a light-diffuser in front of it). Such a reflector or transflector can, for example, be constituted by the combination of a photopolymeric, off-axis, light-transmitting diffuser having the properties described above, with a reflecting or transflective (semi-reflective/semitransmissive) sheet or layer disposed behind it, so that light passes through the diffuser to reach the reflector or transflector, and is reflected by the reflector or transflector to pass forwards through the diffuser again. Such a combination may comprise, for example, a light-transmitting diffuser with a reflector spaced behind it, or bonded or laminated to it, or less preferably, (and subject to chemical compatibility), a light-transmitting diffuser having its rear surface metallised. Where the reflector is transflective, i.e. partly light-transmitting and partly light-reflecting, the optical density of the reflective coating or equivalent should be at least 0.6 and preferably greater than 0.8, (i.e. at least 60% of the light, preferably at least 80%, should be reflected). Where the invention is applied to an LCD display, as described above, whether to a light-transmitting diffuser disposed in front of the liquid crystal or to a diffusing reflector or transflector disposed behind the liquid crystal, it is desirable that the aligned gain of the diffuser or diffuser component, as measured on the normal to the plane of the diffuser, should be at least 10.

It is also within the scope of the present invention to provide a diffusive reflector, incorporating a light-diffusing transmissive sheet or film of the kind described, in combination with a reflector, as a front projection screen in a projection imaging system. In such an application the arrangement will be such that light from the projector arrives at the diffuser at an angle corresponding to the direction of greatest aligned gain (least diffusion) and, after passing through the diffuser to the reflector, is reflected back through the diffuser towards the viewer in a direction corresponding to greater diffusion (lower aligned gain). Where the arrangement is such that the projection screen is arranged generally vertically for viewing by persons seated at various locations in a room, for example, it is also desirable that the diffuser element has asymmetric diffusion characteristics such that light is spread more in the horizontal than the vertical plane as seen by the viewer.

Referring now to FIGS. 5 to 9 of the accompanying drawings, and particularly to FIG. 8, FIG. 8, like FIG. 2a, illustrates schematically the use of an LCD display 20, for example a pixelated LCD display forming the screen of a hand-held device such as a mobile telephone, a PDA, or an electronic game device, which principally depends upon ambient light for viewing the display operated in a mode relying upon ambient illumination. As in FIG. 2a, in FIG. 6, the person viewing the screen has his or her back to the light. In FIG. 8 the LCD display is disposed so as to be perpendicular to the viewer's line of sight, and so the viewer's head 22 blocks the light which would otherwise reach the screen along the normal to the screen, indicated by the broken line. Accordingly, in normal use of such an LCD display, viewed along a line of sight perpendicular to the display, as in FIG. 8, the viewer must rely upon light emanating from areas behind the viewer and above his or her head and/or located to either side of his or her head, so that, as illustrated, the light illuminating the display 20 is incident on the screen 20 at an angle α with respect to the normal. This means that if the light were not diffused in entering the display, or on reflection by the reflector at the back of the display, or on passing out of the display again after such reflection, none of the light would proceed along the normal to the plane of the display to reach the viewer's eye. That is to say, the viewer must rely upon diffusion of light in the display in order to be able to see the display. Whilst, in some applications, it is appropriate, as in FIGS. 2b and 2c for a viewer to tilt the screen 20 relative to his or her line of sight so as to allow reflected light which has not been significantly deviated by diffusion to reach his gaze, in other applications this is not ideal. The display and diffusing screen of the embodiment of the present invention to which FIGS. 5 to 9 relate are preferably optimised for viewing in a range of angles, of the normal to the display to the line of sight, of from 0° to +10°, where an angle of +10° corresponds to the display having been rotated clockwise, in FIG. 8, through 10°.

The applicants have discovered that it is possible to “tailor” the characteristics of a light-diffusing screen to be incorporated in such an LCD display in such a way that light close to the normal viewing axis is little deviated by diffusion whilst light at a significant angle to the normal viewing axis is more widely spread by deviation, so that a significant proportion of such light, in passing through the diffuser, is brought more closely toward alignment with said axis and is thus, e.g. after reflection able to pass out of the display, along said normal axis, to the viewer's eye.

The invention is applicable, inter alia, to a light diffusing sheet disposed in front of such a liquid crystal cell, and also, or alternatively, to a diffusive reflector disposed behind the liquid crystal cell in this context. A light diffusing film of the kind discussed in the preceding paragraph and illustrated in FIG. 8 may, for example, be mounted in an LCD display of the construction illustrated in FIG. 3, with the light diffusing sheet discussed in the preceding paragraph substituted for the sheet 46 of FIG. 3.

Again, a retardation film may be provided directly below the upper polariser 42, above the light diffusing film 46). Likewise, again, instead of (or in addition to) providing light diffusing film 46 in front of the liquid crystal, the reflector or transflector may have light diffusing properties in accordance with the aspect of the invention under discussion with reference to FIGS. 5 to 9.

Referring again to FIG. 8, and assuming the display 20 to incorporate a light diffusing film in accordance with the last-noted aspect of the invention located in place of the light diffusing film 4 in the arrangement of FIG. 3, for the purposes of the discussion which follows, light incident on the diffusing screen in a direction which is inclined downwardly with respect to the normal to the plane of the display is considered, arbitrarily, to be incident at a negative angle with respect to that normal, whilst light exiting through the diffusing screen, after reflection within the display 20, in a direction downwardly and away from the normal, (back towards the viewer in FIG. 8), is considered, arbitrarily, to have a positive angle of inclination with respect to the normal.

The graphs of FIGS. 5 and 6 are obtained, with the diffusing screen sample 12 perpendicular to the axis of the beam from the light source 10, by swinging the detector 14 about the axis O and measuring the intensity of the light received by the detector 14. The “relative intensity” indicated in FIGS. 5 and 6, is the intensity of light so received by detector 14 relative to the intensity of the light received by the detector 14 when it is directly aligned with light source 10 along the axis of the beam from the latter, with no diffusing sample 12 in place. The relative intensity in any position of the detector, is thus directly related to the gain of the diffuser material at the corresponding angle. The position of the detector 14 shown in FIG. 1 is the 0° position of FIGS. 5 and 6. The points in the graphs of FIGS. 5 and 6 indicated at positive angles correspond to measurements made when the detector is swung anti-clockwise through the respective angle, about axis O, as viewed in FIG. 1 and the points indicated at negative angles correspond to measurements made when the detector is swung clockwise through the respective angle about the axis O, as viewed in FIG. 1 and for consistency with this convention, the orientation of the screen 12 from top of FIG. 1 to bottom of FIG. 1 and from left to right of FIG. 1, for the measurements, represented by the graph in FIG. 5, is the same as the orientation of the screen in FIG. 8 from top of FIG. 8 to bottom of the figure and from left to right. FIG. 6 represents the variation in perceived intensity with change of position in a horizontal plane in FIG. 8 (corresponding to looking at the screen in FIG. 8 from one side of the viewer 22 or the other).

The applicants have found, surprisingly, that good viewing properties, in the reflective mode illustrated in FIG. 8, are provided if the diffusion film 46 or the reflector or transflector 48 has the characteristics illustrated by the graphs referenced 45 to 60 in FIGS. 5, 6 and 7. That is to say, if, for light incident on the screen 20 downwardly, from above the viewer's head, and laterally, from either side of the viewer, such light is diffused to a relatively large degree in passing through the screen (low gain), whilst, after reflection in the display, for example, by the reflector or transflector 48, such of the light as passes back through the diffusing layer substantially along or close to the normal to the screen is significantly less diffused (with corresponding higher gain). For clarity, a graph corresponding to FIG. 5 has been superimposed on the display in FIG. 8 to illustrate more clearly the relationship between the viewing conditions and the variation of gain with angle. Subjectively the result of using a light-diffusing film having the characteristics is that the display has, as compared with conventional displays, increased brightness in ambient lighting conditions, when viewed along the normal to the plane of the display, as compared with conventional screens.

As indicated schematically in FIG. 9, the applicants' currently preferred method of producing a diffusion screen material, with the characteristics noted with reference to FIGS. 5 to 8, is by exposure of a layer of a photopolymerisable material 50, supported on a planar transparent substrate 52 to polymerising radiation (indicated by arrows 54) through an optical aperture mask 56, preferably a speckle mask, as described, for example, in WO94/29768 or EP-A-0768565, but with the layer 50 of photopolymer, (or rather the layer 50 of monomer which forms a precursor of the photopolymer layer), in the exposure step, being exposed, through the speckle mask, to collimated (parallel) polymerising radiation 54 which is projected in a direction which is inclined at an angle α with respect to the normal indicated by broken line 58, to the planes of the monomer layer 50 and the superimposed mask 56, whereby, throughout the exposed monomer/polymer, the radiation passes everywhere at the same exposure angle α, through the mask, with respect to the normal to the plane of the layer 50 of monomer/polymer. As explained in more detail in WO94/29768 and EP-A-0768565, and also in EP-A-0294122, the optical mask 56 is in principle an opaque layer in which are formed a plurality of light transmitting areas or apertures, through which the polymerising radiation passes to polymerise the areas of the monomer exposed by such apertures more completely than other areas, as explained in more detail in the above published patent specifications. The apertures are typically of the order of 5μ or less in diameter with spacings between apertures of the same order of magnitude. In the graphs of FIGS. 5, 6 and 7, results are indicated for four different photopolymer light-diffusing screens, produced by the method described above with reference to FIG. 9, the four screens differing only in the angle α to which the monomer layer 50 was inclined relative to the direction of incident radiation 54 during exposure. In FIGS. 5, 6, and 7, the graphs marked “α=3.5 deg.”; “α=5 deg.” and so on, signify that, in manufacture of a diffusing screen in the manner described above, the exposure angle α of the polymerising radiation, through the mask, as illustrated in FIG. 9, relative to the normal 58 to the plane of the layer of monomer/polymer was 3.5 degrees; 5 degrees, etc. The results illustrated in FIGS. 5 and 6 relate to a test regime in which the plane of the light diffusing screen was maintained perpendicular to the axis A of the incident beam from the light source 10.

It will be noted that, surprisingly, the pronounced increase in gain, along the normal to the plane of the display in comparison with gain along directions inclined to the plane of the display, such as to render the light-diffusing material particularly suitable for the viewing conditions illustrated in FIG. 8 occurs with diffusion screen material exposed by radiation directed onto the monomer layer/mask combination at large angles, of up to at least 55° to the normal to the plane of that combination. The results illustrated in FIG. 7 relate to a test regime in which the optical axis of the detector 14 in FIG. 1 was kept in coincidence with that of the light source 10, whilst the inclination of the diffusion sheet (sample 12) relative to the axis of the light source 10 was varied. Positive angles in FIG. 7 correspond with displacement of the sample clockwise from the position shown in FIG. 1 and negative angles to displacement anti-clockwise from the position shown in FIG. 1, with the orientation of the screen material, top to bottom in FIG. 1 being the same as its orientation top to bottom in FIG. 8. FIG. 7 illustrates that the gain increases with the exposure angle α (see above) and remains high for light traversing the photopolymer layer off-axis at even relatively large angles.

It will be noted that the light diffusing sheets produced are asymmetrical in their diffusion characteristics, in the sense that the off-axis diffusion is less (FIG. 5) for the test regime in which the exposure axis, i.e. the axis relative to the plane of the screen material, corresponding to the axis of the polymerising beam during the exposure step of FIG. 9 for that particular diffusion sheet or sample) lies in the plane of the figure in FIG. 1, than for the case (FIG. 6) in which the exposure axis perpendicular to the plane of the figure in FIG. 1.

It is possible to produce results similar to those described either using a transmissive light-diffusing film (46), having the properties described, in front of the LCD cell, or using a light-diffusing reflector or transflector, having corresponding off-axis properties, behind the liquid crystal cell, (or indeed by having such a reflector or transflector behind the liquid crystal cell in addition to such a light-diffuser in front of it). Such a reflector or transflector can, for example, be constituted by the combination of a photopolymeric, light-transmitting diffuser having the properties described above, with a reflecting or transflective (semi-reflective/semi-transmissive) sheet or layer disposed behind it, so that light passes through the diffuser to reach the reflector or transflector, and is reflected by the reflector or transflector to pass forwards through the diffuser again. Such a combination may comprise, for example, a light-transmitting diffuser with a reflector spaced behind it, or bonded or laminated to it, or less preferably, (and subject to chemical compatibility), a light-transmitting diffuser having its rear surface metallised. Where the reflector is transflective, i.e. partly light-transmitting and partly light-reflecting, the optical density of the reflective coating or equivalent should be at least 0.6 and preferably greater than 0.8, (i.e. at least 60% of the light, preferably at least 80%, should be reflected). Where the invention is applied to an LCD display, as described above, whether to a light-transmitting diffuser disposed in front of the liquid crystal or to a diffusing reflector or transflector disposed behind the liquid crystal, it is desirable that the aligned gain of the diffuser or diffuser component, as measured on the normal to the plane of the diffuser, should be at least 20 and the maximum should occur, as shown in FIG. 7, where the normal to the plane of the diffuser sheet is inclined at no more than 200 to the axis of the light source and detector in the testing conditions illustrated in FIG. 1.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A light-diffusing sheet or screen which is generally planar and has off-axis characteristics such that the maximum aligned gain, as herein defined, is at a significant angle with respect to the normal to the plane of the sheet or screen.

2. A light-diffusing sheet or screen according to claim 1, which is a light-transmitting diffusing screen.

3. A light-diffusing sheet or screen according to claim 1, which is a light-reflecting diffusing screen.

4. A light-diffusing sheet or screen according to claim 1, which is partly light-transmitting and partly light-reflecting.

5. A light-diffusing sheet or screen according to any preceding claim, wherein the maximum aligned gain, as herein defined, is at least 20% greater than that on the normal to the plane of the sheet or screen.

6. A light-diffusing sheet or screen according to any preceding claim, wherein the aligned gain, as herein defined, on the normal to the plane of the sheet or screen, is at least 10.

7. A light-diffusing sheet or screen according to any preceding claim wherein the maximum aligned gain is at an angle of from 10° to 50° with respect to the normal to the plane of the screen or sheet.

8. A light-diffusing sheet or screen according to any preceding claim wherein the maximum aligned gain is at an angle of from 25° to 40° with respect to the normal to the plane of the screen or sheet.

9. A light-diffusing sheet or screen according to any of claims 1 to 8 which is, or which incorporates, a photopolymer diffuser in which the light diffusive characteristics are due at least partly to refractive index variations within the material of the diffuser.

10. An LCD or the like display incorporating a light transmissive diffuser in front of the liquid crystal so as to be interposed between the liquid crystal and the viewer, and wherein said light diffuser is an off-axis diffuser, as herein defined, disposed so that the maximum aligned gain, as herein defined, is at an angle above the normal to the plane of the LCD display, in the normal viewing orientation of the display.

11. An LCD or the like display incorporating a light-diffusing reflector or transflector behind the liquid crystal cell for reflecting light through the cell to the viewer, and wherein said light-diffusing reflector or transflector comprises, in combination, a light-transmitting diffuser and a reflector or transflector proper behind the diffuser, and wherein the diffuser is an off-axis diffuser, as herein defined, disposed so that the maximum aligned gain, as herein defined, is at an angle above the normal to the plane of the LCD display, in the normal viewing orientation of the display.

12. A display according to claim 10 or claim 11 incorporating both such a light-transmissive diffuser in front of the liquid crystal and such a light-diffusing reflector or transflector behind the liquid crystal.

13. A display according to any of claims 10 to 12 wherein the maximum aligned gain, as herein defined, is in a vertical plane perpendicular to the plane of the display, in the normal viewing orientation of the display.

14. A display according to any of claims 10 to 13 wherein the maximum aligned gain, as herein defined, of the diffuser, is at an angle from 10° to 50° above the normal to the plane of the display, in the normal viewing orientation of the display.

15. A display according to claim 14 wherein the maximum aligned gain, as herein defined, is at an angle from 25° to 40° above the normal to the plane of the display, in the normal viewing orientation of the display.

16. A display according to claim 14 or claim 15 wherein the maximum aligned gain, as herein defined, in the quadrant above the normal to the plane of the display, is 20% greater than that on the normal to that plane whilst the aligned gain in the quadrant below the normal to the plane of the display is less than that on said normal, all in the normal viewing orientation of the display.

17. A light-diffusing, light-reflecting front projection screen comprising, in combination, a light-transmitting diffuser and a reflector or transflector (or a reflective or transflective layer) behind the diffuser, whereby light projected onto the projection screen will pass through the diffuser to be reflected by the reflector or transflector (or by the reflective or transflective layer) back through the diffuser, and wherein the diffuser has off-axis light diffusing characteristics such that the maximum aligned gain, as defined herein, of the diffuser, is along an axis at a predetermined substantial angle to the normal to the diffuser.

18. A display according to any of claims 10 to 16, or a screen according to claim 17, wherein the diffuser is a photopolymer diffuser in which the light diffusive characteristics are due at least partly to refractive index variations within the material of the diffuser.

19. An LCD or the like display incorporating a light-diffusing sheet or screen which is generally planar and is so arranged that the maximum gain, as herein defined, of the light-diffusing sheet, is at an angle in the range of 0°, (i.e. substantially normal to the plane of the sheet or screen), to +20°, (as herein defined) to said normal, preferably in the range 0° to +10°.

20. A display according to claim 19, wherein said light-diffusing screen is light-transmitting.

21. A display according to claim 19, wherein said light-diffusing screen is light-reflecting.

22. A display according to claim 19, wherein said diffusing screen is partly light-transmitting and partly light-reflecting.

23. A light-diffusing sheet or screen which is, or which incorporates, a photopolymer diffuser in which the light diffusive characteristics are due at least partly to refractive index variations within the material of the diffuser, and wherein said refractive index variations define graded refractive index lenses or analogous optical features having optical axes which are inclined by more than 30° with respect to the normal to the plane of such sheet or screen.

24. An LCD or the like display incorporating a light-transmissive diffuser in front of the liquid crystal so as to be interposed between the liquid crystal and the viewer, and wherein said light diffuser is disposed so that the maximum gain, as herein defined, is at an angle in the range of 0° (i.e. along the normal to the plane of the LCD display), to +20°, (as herein defined) to said normal, preferably in the range 0° to +10°.

25. A display according to claim 19 or claim 24 wherein the maximum gain of the diffuser is at substantially +5°, as herein defined, to the normal to the plane of the display.

26. A display according to claim 24 or claim 25, incorporating both such a light-transmissive diffuser in front of the liquid crystal and such a light-diffusing reflector or transflector behind the liquid crystal.

27. A display according to claim 24 wherein said light diffusing sheet or screen is a sheet or screen according to claim 5.

28. A display according to claim 27, or a screen according to claim 23, wherein the diffuser is a photopolymer diffuser in which the light diffusive characteristics are due at least partly to refractive index variations within the material of the diffuser, and in which said refractive index variations have been produced by exposure of a layer of photopolymerisable material through a superimposed aperture mask, to a beam of polymerising radiation directed onto the mask and layer along an axis inclined at at least 30° with respect to the plane of said mask and layer.
